(19) United States
(12) Patent Application Publication
(10) Pub. No.: US 2018/0209493 A1
(43) Pub. Date: Jul. 26, 2018

(54) CONTROL OF AN ACTUATOR FOR ACTUATING A MOTOR VEHICLE CLUTCH

(71) Applicant: GM GLOBAL TECHNOLOGY OPERATIONS LLC, Detroit, MI (US)

(72) Inventors: Paul Peter Dippe, Mainz (DE); Yaya Kaba, Nauheim (DE); Manuel Frommann, Mainz (DE)

(73) Assignee: GM GLOBAL TECHNOLOGY OPERATIONS LLC, Detroit, MI (US)

(21) Appl. No.: 15/874,465

(22) Filed: Jan. 18, 2018

(30) Foreign Application Priority Data
Jan. 19, 2017 (DE) 102017000444.7

(51) Int. Cl. F16D 48/06; F16H 63/46

(52) U.S. Cl. CPC F16D 48/06; F16H 63/46; F16D 2500/102; F16D 2500/10412; F16D 2500/50236; F16D 2500/1107; F16D 2500/30806; F16D 2500/31466; F16D 2500/1045

(57) ABSTRACT

A method is disclosed for controlling an actuator to activate a motor vehicle clutch. A shift operation is acquired for a motor vehicle transmission. A shift actuator is controlled as a function of the acquired shift operation. The acquisition of the shift operation includes acquiring an operational force that is exerted on a shift mechanism during the operation, A shifting duration for the shift operation and/or a clutch adjustment duration (i.e., disengaging and/or engaging) of the motor vehicle clutch is modified as a function of the acquired shift operation.

### CROSS-REFERENCE TO RELATED APPLICATION

This application claims priority to German Patent Application No. 10 2017 000 444.7, filed Jan. 19, 2017, which is incorporated herein by reference in its entirety.

### TECHNICAL FIELD

The present disclosure pertains to a method and a control system for controlling an actuator for activating a motor vehicle clutch, as well as to a motor vehicle, such as a passenger car, with the control system and a computer program product for implementing the method.

### BACKGROUND

Motor vehicles may be equipped with a transmission, a gearshift for shifting the transmission, a clutch, and an actuator system for automatically activating the clutch. The actuator disengages when the driver disengages a gear with the gearshift, and engages when the driver engages a gear with the gearshift.

### SUMMARY

In accordance with the present disclosure, a method is disclosed for controlling an actuator to automatically activate a motor vehicle clutch. A manual operation of a gear shift is acquired for electrically or electronically shifting a motor vehicle transmission and/or for electrically or electronically processing shift commands. The actuator is controlled as a function of this acquired operation.

In an embodiment of the present disclosure, a control system for controlling the actuator implements a method described herein using hardware and/or software configured to acquire the operation of the gear shift for electrically or electronically shifting a motor vehicle transmission and/or for electrically or electronically processing shift commands, and to control the actuator as a function of this acquired operation.

In an embodiment, the motor vehicle clutch is a separating clutch which selectively and partially or completely couples a drive member through the transmission to a driven member. The drive member may be at least one internal combustion engine and/or at least one electric engine. The driven member may be at least one of drive element and/or at least one drive wheel.

In an embodiment, the actuator is activated by a hydraulic, pneumatic, electric, magnetic and/or motorized actuator, which actuates, in particular engages and/or disengages, the motor vehicle clutch. For example, the actuator may be an electric motor and/or electromagnet actuator. In an embodiment, the motor vehicle clutch may advantageously be actuated more quickly and precisely by the driver with less wear and/or effort than with a manual clutching system.

In an embodiment, the gear shift may be a gear lever for selecting gears of a motor vehicle transmission via signaling corresponding to shift commands. In an embodiment, the shift operation is a manual operation or gear adjustment by the driver of the motor vehicle.

In an embodiment, the motor vehicle transmission can advantageously be shifted by the driver more quickly and precisely by the driver in an intuitive manner with less wear and/or effort than with a manual clutching system.

In an aspect of the present disclosure, acquiring the manual operation of the gear shift involves acquiring an operational force that is exerted on the gear shift during the operation. Accordingly, the control system or the gear shift as the case may be is configured to acquire an operational force that is exerted on the gear shift during the operation for acquiring an operation of the gear shift.

In an embodiment, the operational force is acquired with or without contact through electrical, magnetic and/or hydraulic means, in particular by a uniaxial or multiaxial force and/or torque sensor configured for this purpose. In a particular embodiment, the sensor is coupled with the gear shift or arranged at, on or in the gear shift. For example, the sensor may include one or more strain gauges and/or extensometers, in particular measuring strips. Accordingly, the sensor(s) for acquiring the operational force in an embodiment is a means for acquiring the operational force such that the operational force may be acquired more quickly, reliably and precisely.

In an aspect of the present disclosure, acquiring an operation of the gear shift additionally or alternatively involves acquiring a shifting duration for the operation of the gear shift. Accordingly, the control system and/or the gear shift is configured, in an embodiment, to acquire the shifting duration for the operation of the gear shift.

In an embodiment, the shifting duration is acquired with or without contact through electrical, magnetic and/or hydraulic means, in particular by a uniaxial or multiaxial distance, contact and/or position sensor configured for this purpose. In particular, one or more sensors acquire one or several positions or positional changes for the gear shift or are configured for this purpose. Accordingly, the sensor(s) for acquiring the shifting duration in an embodiment is a means for acquiring the shifting duration such that the operational force may be acquired more quickly, reliably and precisely.

In an aspect of the present disclosure, an opening duration, in particular ramp, of the motor vehicle clutch is additionally or alternatively modified (e.g., increased or decreased) as a function of the acquired operation. Accordingly, the control system is configured to modify the opening duration or ramp of the motor vehicle clutch as a function of the acquired operation.

In an aspect of the present disclosure, a closing duration, in particular ramp, of the motor vehicle clutch is additionally or alternatively modified (e.g., increased or decreased) as a function of the acquired operation. Accordingly, the control system is configured to modify the closing duration or ramp of the motor vehicle clutch as a function of the acquired operation.

In an embodiment, the opening or closing duration depends on a commanded and/or executed opening, closing or transferring of the motor vehicle clutch between a first (partially or completely open) position and a second (partially or completely closed) position for influencing, prescribing or otherwise defining the latter.

In an embodiment, the driver can advantageously influence a characteristic of activating the motor vehicle clutch by controlling the actuator as a function of the acquired operational force and/or shifting duration. In particular, the driver may optionally or intentionally modify (e.g., shorten or lengthen) the opening and/or closing duration of the clutch.

In an embodiment, the activation of the motor vehicle clutch can in particular be advantageously adjusted to various requirements or particular driving situations by modifying the opening and/or closing duration of the motor vehicle clutch as a function of the acquired operation, namely the operational force and/or shifting duration.

As a result of the above, two or more of these aspects may be advantageously being combined, sequentially implemented or taken separately.

In an embodiment, the actuator for activating the motor vehicle clutch is controlled in a first operation, in particular a first mode or type, if a first operational force exerted on the gear shift is acquired, and/or the motor vehicle clutch is actuated in this operation with a first opening duration or ramp, and/or a first closing duration or ramp. Additionally and/or alternately, the actuator for activating the motor vehicle clutch is controlled in a second operation, in particular a second mode or type, if a second operational force different from the first operational force exerted on the gear shift is acquired, and/or the motor vehicle clutch is activated with a second opening duration or ramp, which is shorter than the first opening duration or ramp, and/or a second closing duration or ramp, which is shorter than the first closing duration or ramp.

Accordingly, the control system in an embodiment has a controller configured to operate the actuator for actuating the motor vehicle clutch in a first operation, mode or type if a first operational force exerted on the gear shift is acquired and/or wherein, in this first operation, mode or type the motor vehicle clutch is actuated in this operation with a first opening duration or ramp, and/or a first closing duration or ramp. The controller is configured to operate the actuator for actuating the motor vehicle clutch in a second operation, mode or type if a second operational force different from the first operational force exerted on the gear shift is acquired and/or wherein, in this second operation, mode or type the motor vehicle coupling is activated with a second opening duration or ramp, which is shorter than the first opening duration or ramp, and/or a second closing duration or ramp, which is shorter than the first closing duration or ramp.

In an embodiment, a maximum and/or average amount of the first operational force is greater than the corresponding amount of the first operational force and/or a first time derivative (or higher time derivative) of the second operational force, in terms of amount, is greater than the corresponding derivative of the first operational force and/or a time integral of the second operational force, in terms of amount, is greater than the corresponding integral of the first operational force.

In an embodiment, the opening and/or closing duration or ramp is shortened if the gear shift is operated with an operational force or an operational force is exerted on the gear shift or an operational force exerted on the gear shift is acquired which is greater, in particular has a higher maximum and/or average value, is built up faster and/or whose effect is greater.

In a further development, the actuator for activating the motor vehicle clutch in a third operation, mode or type, is controlled if a third operational force different from the first and second operational force exerted on the gear shift is acquired and/or wherein, in this third operation, the motor vehicle clutch in this this operation, mode or type is activated with a third opening duration or ramp, which is even shorter than the second opening duration or ramp, and/or a third closing duration or ramp, which is even shorter than the second closing duration, in particular ramp.

Accordingly, the control system in a further development is configure to control the actuator for activating the motor vehicle clutch in a third operation, mode or type is controlled if a third operational force, different from the first and second operational force, exerted on the gear shift is acquired, and/or wherein, in this third operation, mode or type the motor vehicle clutch in this third operation, mode or type is activated with a third opening duration or ramp, which is even shorter than the second opening duration, in particular ramp, and/or a third closing duration or ramp, which is even shorter than the second closing duration, in particular ramp.

In an embodiment, a maximum and/or average amount of the third operational force is even greater than the corresponding amount of the second operational force and/or an first time derivative (or higher time derivative) of the third operational force, in terms of amount, is even greater than the corresponding derivative of the second operational force and/or a time integral of the third operational force, in terms of amount, is even greater than the corresponding integral of the second operational force.

In an embodiment, the opening and/or closing duration or ramp is thus shortened even further if the gear shift is operated with an operational force or an operational force is exerted on the gear shift or an operational force exerted on the gear shift is acquired which is greater, maximally and/or on average, in particular has an even higher maximum and/or average value, is built up even faster and/or whose effect is even greater.

In this way, the driver can adjust the opening and/or closing duration of the motor vehicle clutch advantageously in more quickly, reliably and precisely and in an intuitive manner, to various requirements and/or particular driving situations.

In an embodiment, the actuator for activating the motor vehicle clutch is additionally or alternatively controlled in an operation, mode or type if a first shifting duration is acquired and/or wherein, in this operation, mode or type the motor vehicle clutch is activated in this operation, mode or type with a first opening duration or ramp, and/or a first closing duration or ramp, and controlled in a second operation, mode or type, if a second shifting duration different from the first shifting duration is acquired, and/or wherein, in this second operation, mode or type, the motor vehicle clutch is activated with a second opening duration or ramp, which is shorter than the first opening duration or ramp, and/or a second closing duration or ramp, which is shorter than the first closing duration or ramp.

Accordingly, the control system in a further development is configured to control the actuator for actuating the motor vehicle clutch in an operation, mode or type, if a first shifting duration is acquired and/or wherein, in this operation, mode or type the motor vehicle clutch is activated in this operation with a first opening duration or ramp, and/or a first closing duration or ramp, and activated in second operation, mode or type, if a second shifting duration different from the first shifting duration is acquired, and/or wherein, in this second operation, mode or type the motor vehicle clutch is activated with a second opening duration or ramp, which is shorter than the first opening duration or ramp, and/or a second closing duration or ramp, which is shorter than the first closing duration or ramp.

In an embodiment, a period between a first and a second acquired position of the gear shift, in particular a deselection or a commanded disengagement of a gear and a selection or commanded engagement of a gear, and a second shifting duration is shorter than in the first shifting duration, in particular the first and second shifting durations are the respective period between the acquisition of the same positions of the gear shift or the acquired period for the same position changes of the gear shift or its transfer between the same positions, in particular the end or intermediate positions, for example from a respective first into a second gear, from the same respective travel gear into neutral or a neutral gear or position, from a respective neutral or a neutral gear or position into the same travel gear, or the like.

In an embodiment, the opening and/or closing duration or ramp, is thus shortened if the gear shift are operated faster, or a shorter shifting duration is acquired between two positions, in particular intermediate or end positions, of the gear shift.

In a further development, the actuator for actuating the motor vehicle clutch is controlled in third operation, mode or type if a third shifting duration different from the first and second operational force is acquired, and/or wherein, in this third operation, mode or type, the motor vehicle clutch is activated with a third opening duration or ramp, which is shorter than the second opening duration or ramp, and/or a third closing duration or ramp, which is shorter than the second closing duration or ramp.

Accordingly, the control system or its means in a further development have means for controlling the actuator for activating the motor vehicle clutch in another operation, in particular in another (operating) mode or another operation type, if a third shifting duration different from the first and second shifting duration is acquired, and/or wherein, in this other operation, the motor vehicle clutch is activated with a third opening duration, in particular ramp, which is shorter than the second opening duration, in particular ramp, and/or a third closing duration, in particular ramp, which is shorter than the second closing duration, in particular ramp.

In an embodiment, the period between a first and a second acquired position of the gear shift, in particular a deselection or disengagement of a gear and a selection or engagement of a gear is even shorter for the third shifting duration than for the second shifting duration, in particular the first, second and third shifting durations are the respective period between the acquisition of the same positions of the gear shift or the acquired period for the same position changes of the gear shift or its transfer between the same positions, in particular the end or intermediate positions, for example from a respective first into a second gear, from the same respective travel gear into neutral or a neutral gear or position, from a respective neutral or a neutral gear or position into the same travel gear, or the like.

In an embodiment, the shifting duration is acquired specific to gear changes, for example by dividing the period between a first and a second acquired position of the gear shift by a reference value for this position change. This type of standardization advantageously makes it possible to consider that a gear change between more closely adjacent gears takes place faster, for example. Accordingly, the control system in a further development is configured to acquire the shifting duration specific to gear changes.

In an embodiment, the opening and/or closing duration or ramp is thus shortened even further if the gear shift is operated even faster or an even shorter shifting duration is acquired between two positions, in particular end positions of the gear shift.

In this way, the driver in an embodiment can adjust the opening and/or closing duration of the motor vehicle clutch advantageously, in particular more quickly reliably, and/or precisely and in an intuitive manner to various requirements or particular driving situations.

In an embodiment, an allocation between an acquired operation of the gear shift, in particular the operational force, for example, its maximum and/or average amount, and/or a time derivative and/or a time integral thereof, and/or the shifting duration, in particular a period between a first and a second acquired position of the gear shift, for example a deselection or disengagement of a gear and a selection or engagement of a gear on the one hand and an allocated control of the actuator, for example a one- or multi-dimensional control parameter for controlling the actuator, in particular for modifying (e.g., shortening or lengthening) an opening and/or closing duration or ramp of the motor vehicle clutch is adjustably or fixedly or invariably prescribed in a further development by a one- or multi-dimensional relation or function of a characteristic diagram or the like.

In an embodiment, the opening and/or closing duration is modified (e.g., shortened or lengthened) as a function of the acquired operational force, for example its maximum and/or average amount, and/or a time derivative and/or a time integral thereof, and/or the acquired shifting duration, in particular a period between a first and a second acquired position of the gear shift, for example a deselection or disengagement of a gear and a selection or engagement of a gear, in particular prescribed by an adjustably or fixedly or invariably prescribed initial or reference value and/or up to an adjustably or fixedly or invariably prescribed extreme, minimum or maximum value, and/or at least partially proportional, degressive or progressive.

In this way, the driver in an embodiment can adjust the opening and/or closing duration of the motor vehicle clutch advantageously, in particular more quickly, reliably, and/or precisely in an intuitive manner to various requirements or particular driving situations.

Within the meaning of the present disclosure, a controller or control means may be configured like hardware and/or software, in particular have a digital processing or microprocessor unit (CPU) data- or signal-connected with a memory and/or bus system, and/or have one or several programs or program modules. The CPU can be designed to process commands implemented as programs or program modules saved in a storage system, and/or communicate input signals from a data bus and/or output signals to the data bus. A storage system can have one or several, in particular different, storage media, for example optical, magnetic, solid state and/or other nonvolatile, non-transitory computer readable media. The program can be constituted in such a way as to be able to embody or implement the methods described here, so that the CPU can implement the steps in such methods, and thus in particular control the actuator or motor vehicle clutch or its activation by the actuator.

In an embodiment, one or several, in particular all, steps of the method are completely or partially automatically implemented, in particular by the control system or its controller.

### BRIEF DESCRIPTION OF THE DRAWINGS

The present disclosure will hereinafter be described in conjunction with the following drawing figures, wherein like numerals denote like elements.

FIG. 1 is part of a motor vehicle with an actuator and a control system for controlling the actuator according to an embodiment of the present disclosure;

FIG. 2 is a flowchart illustrating a method for controlling the actuator according to an embodiment of the present disclosure, and

FIG. 3 illustrates three operations of the actuator.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

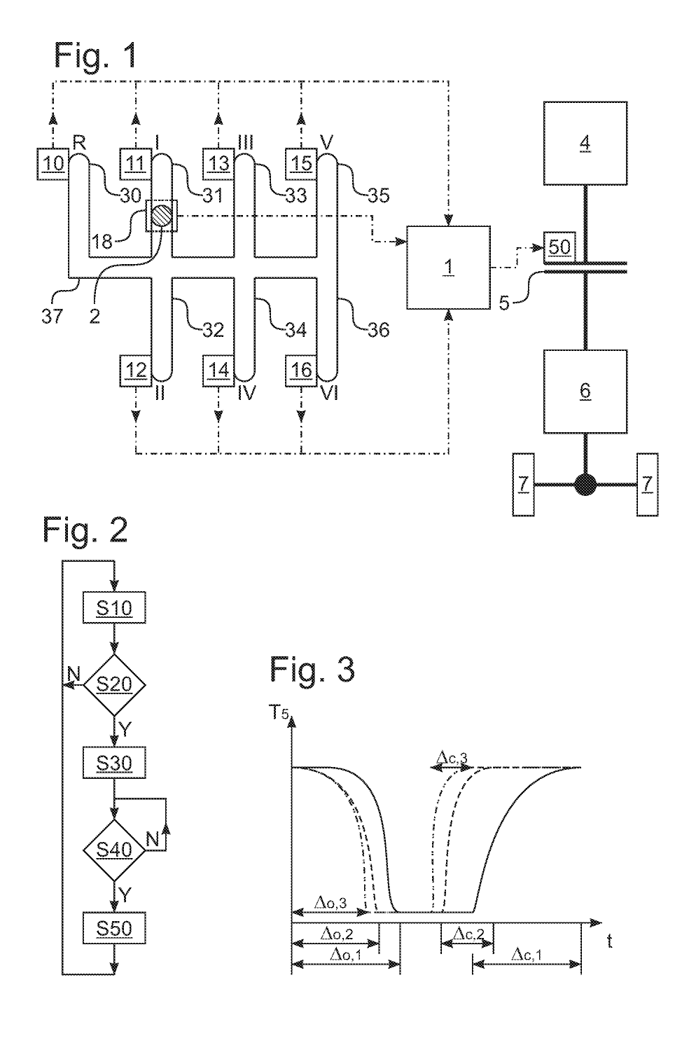

FIG. 1 schematically illustrates a part of a motor vehicle according to an embodiment of the present disclosure with a drive 4 for driving drive wheels 7 via a motor vehicle transmission 6, which a motor vehicle clutch 5 can optionally couple to or decouple from the drive 4, which can be electrically adjusted or activated by an actuator 50.

In order to shift the motor vehicle transmission 5, the driver operates a gear shift in the form of a gear shift 2, which in a shifting gate is guided with a reverse gear alley 30, an alley with a first branch 31 and a second branch 32, another alley with a third branch 33 and a fourth branch 34 and another alley with a fifth branch 35 and a sixth branch 36.

A control system with an controller or electronic clutch unit acquires a position or positional change of the gear shift 2 and opens the motor vehicle clutch 5 when it acquires (the beginning) of a disengagement motion to or a disengagement of a gear by the gear shift 2, and closes the motor vehicle clutch 5 when it has acquired an executed engagement motion to or an engagement of a gear by the gear shift 2 by correspondingly controlling the actuator 50.

For this purpose, the exemplary embodiment provides contact sensors 10 through 16 in the shifting gates 30 through 36, which are signal-connected with the ECU 1: If one of these contact sensors 10-16 acquires the gear shift 2, a completed engagement of the corresponding gear is acquired. If this contact sensor then acquires a detachment of this contact, a beginning of a disengagement of the corresponding gear is acquired. In certain modifications, this can naturally also be acquired in another way.

Arranged on the gear shift 2 is a force sensor with one or several strain gauges 18, which acquire a signal representative of the operational force exerted on the gear shift 2 and transmits the signal to the ECU 1, with which it is signal-connected.

The control system with the ECU 1 implements a method for controlling the actuator 50 for automatically activating the motor vehicle clutch 5 according to an embodiment of the present disclosure, which will be described below with reference to FIGS. 2, 3.

The contact sensors 10-16 acquire a disengagement of an engaged gear in a step S10. Step S10 is repeated for as long as no beginning of a disengagement motion for the disengagement of an engaged gear is acquired (S20: “N”). Otherwise (S20: “Y”), the ECU 1 opens the motor vehicle clutch 5 in a step S30 by correspondingly actuating the actuator 50 for this purpose.

In a step S40, the ECU 1 uses the contact sensors 10-16 to check whether a gear has been completely engaged by the gear shift 2. Step S40 is repeated for as long as this is not the case (S40: “N”). Otherwise (S40: “Y”), the ECU 1 closes the motor vehicle clutch 5 in a step S50 by correspondingly actuating the actuator 50 to this end, and returns to step S10.

To this end, a solid line on FIG. 3 shows the progression of a torque T5 transferable by the motor vehicle clutch 5 over time t. The solid line represents an opening duration or ramp Δo,1 and a closing duration or ramp Δc,1.

A timer may also started in step S30, i.e., with the disengagement of a gear, and a maximum amount of operational force exerted by the driver on the gear shift 2 is acquired by means of the force sensor 18. In step S30, the ECU 1 shortens the opening duration or ramp to a prescribed minimum value, proportionally to this maximum amount.

To this end, a dashed line on FIG. 3 shows a shortened opening duration or ramp Δo,2 for a larger maximum operational force in terms of amount, and a dashed-double dotted line shows an even further shortened opening duration or ramp Δo,3 for an even larger maximum operational force in terms of amount.

As a consequence, the actuator 50 for activating the motor vehicle clutch 5 is controlled in an operation by activating the motor vehicle clutch with a first opening duration or ramp Δo,1 when a first operational force exerted on the gear shift 2 is acquired, controlled in another operation in which the motor vehicle clutch 5 is activated with a second opening duration or ramp Δo,2 shorter than the first opening duration or ramp Δo,1, when a second operational force exerted on the gear shift 2 is acquired whose maximum amount is larger than for the first operational force, and controlled in a third or further operation in which the motor vehicle clutch 5 is activated with a third opening duration or ramp Δo,3 even shorter than the second opening duration or ramp Δo,2, when a third operational force exerted on the gear shift 2 is acquired whose maximum amount is even larger than for the second operational force.

In step S50, the timer is additionally stopped, and thus indicates a shifting of the gearshift 2 from the disengagement of a gear (S20: “Y”) to the engagement of a gear (S40: “Y”).

The quotient of the value for the timer divided by a reference value specific to a gear change is acquired as the shifting duration. In step S50, the ECU 1 shortens the closing duration or ramp to a prescribed minimum value, proportionally to this shifting duration.

To this end, a dashed line on FIG. 3 once again shows a shortened closing duration or ramp Δo,2, and a dash-double dotted line exemplarily shows an even further shortened closing duration or ramp Δo,3.

As a consequence, the actuator 50 for activating the motor vehicle clutch 5 is controlled in an operation by activating the motor vehicle clutch with a first closing duration or ramp Δc,1 when a first shifting duration between a disengagement of a gear and an engagement of a gear is acquired, controlled in another second operation in which the motor vehicle clutch 5 is activated with a second closing duration or ramp Δc,2 shorter than the first closing duration or ramp Δc,1, when a shorter second shifting duration between disengagement and engagement is acquired, and controlled in a third or further operation in which the motor vehicle clutch 5 is activated with a third closing duration or ramp Δc,3 even shorter than the second closing duration or ramp Δc,2, when an even shorter third shifting duration between disengagement and engagement is acquired.

When controlling the actuator 5, the ECU 1 thus shortens the opening and/or closing duration or ramp of the motor vehicle clutch 5 as a function of the acquired operational force and shifting duration of the operation.

Even though exemplary embodiments were explained in the preceding description, let it be noted that a plurality of modifications is possible. For example, in order to modify the opening or closing duration or ramp, the period from when a gear was disengaged or a contact was released until when the selection alley 37 was reached, the period from when the selection alley 37 was exited until a gear was engaged or a contact was closed or the like can be taken as the basis instead of the period between when the release of a contact was acquired and the closing of a contact was acquired by the contact sensors 10-16, i.e., only how fast the driver disengages the engaged gear, only how fast the driver engage the new gear or the like.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-10. (canceled)

11. A method for actuating a motor vehicle clutch comprising:
acquiring an actuation parameter of a manual gear shift for a transmission shift input; and
controlling an actuator to operate the clutch using an actuator operation having a closing ramp and an opening ramp in response to the transmission shift; and
modifying the operation as a function of the actuation parameter.

12. The method according to claim 11, wherein the actuation parameter is a shift force applied to the manual gear shift, the method further comprising:
controlling the actuator to operate the clutch using a first actuator operation having a first closing ramp and a first opening ramp when the shift force having a first actuation force; and
controlling the actuator to operate the clutch using a second actuator operation having a second closing ramp and a second opening ramp when the shift force has a second actuation force different than the first actuation force;
wherein at least one of the second closing ramp and the second opening ramp are shorter than the corresponding first closing ramp and the first opening ramp.

13. The method according to claim 12 further comprising controlling the actuator to operate the clutch using a third actuator operation having a third closing ramp and a third opening ramp when the shift force has a third actuation force different than the first and second actuation force;
wherein at least one of the third closing ramp and the third opening ramp are shorter than the corresponding second closing ramp and the second opening ramp.

14. The method according to claim 12, further comprising computing a function of the shift force, wherein the function is selected from the group consisting of a maximum of the shift force, an average of the shift force, a time derivative of the shift force, a time integral of the shift force or a combination thereof and the second actuation parameter is greater than the first actuation parameter.

15. The method according to claim 11, wherein the actuation parameter is a shift duration applied to the manual gear shift, the method further comprising:
controlling the actuator to operate the clutch using a first actuator operation having a first closing ramp and a first opening ramp when the shift force having a first actuation duration; and
controlling the actuator to operate the clutch using a second actuator operation having a second closing ramp and a second opening ramp when the shift force has a second actuation duration different than the first actuation duration;
wherein at least one of the second closing ramp and the second opening ramp are shorter than the corresponding first closing ramp and the first opening ramp.

16. The method according to claim 15, wherein the actuation parameter is the shift duration applied to the manual gear shift, the method further comprising:
controlling the actuator to operate the clutch using a third actuator operation having a second closing ramp and a second opening ramp when the shift force has a third actuation duration different than the first and second actuation durations;
wherein at least one of the third closing ramp and the third opening ramp are shorter than the corresponding second closing ramp and the second opening ramp.

17. The method according to claim 15, further comprising computing a function of the shift duration, wherein the function is selected from the group consisting of a maximum of the shift duration, an average of the shift duration, a time derivative of the shift duration, a time integral of the shift duration or a combination thereof and the second actuation parameter is greater than the first actuation parameter.

18. The method according to claim 15, further comprises acquiring a position of the gear shift, wherein the shift duration is a period between a first acquired position of the gear shift and a second acquired position of the gear shift.

19. The method according to claim 18, wherein the first acquired position is a deselection of a given gear.

20. The method according to claim 19, wherein the second acquired position is a selection of a given gear.

21. A non-transitory computer readable medium comprising processor-executable instructions for reading data from a processor in communication with a manual gear shift for a motor vehicle transmission, the processor-executable instructions when executed on the processor in a control system configure the control system to:
acquire an actuation parameter from the manual gear shift for a transmission shift input, wherein the actuation parameter includes at least one of a shift force and a shift duration; and
control an actuator to operate the clutch using an actuator operation having a closing ramp and an opening ramp in response to the transmission shift; and
modify the operation as a function of the actuation parameter.

22. A control system for controlling an actuator to operate a clutch in a motor vehicle transmission comprising a controller configured to:
acquire an actuation parameter from a manual gear shift indicating a transmission shift input, wherein the actuation parameter includes at least one of a shift force and a shift duration;
control the actuator using an actuator operation having a closing ramp and an opening ramp in response to the transmission shift;
modify a duration for at least one of the opening ramp and the closing ramp as a function of the actuation parameter.

23. The control system according to claim 22, wherein the actuation parameter is the shift force applied to the manual gear shift and the controller is further configured to:
control the actuator to operate the clutch using a first actuator operation having a first closing ramp and a first opening ramp when the shift force having a first actuation force; and
control the actuator to operate the clutch using a second actuator operation having a second closing ramp and a second opening ramp when the shift force has a second actuation force different than the first actuation force;
wherein at least one of the second closing ramp and the second opening ramp are shorter than the corresponding first closing ramp and the first opening ramp.

24. The control system according to claim 22, wherein the actuation parameter is the shift duration applied to the manual gear shift and the controller is further configured to:
control the actuator to operate the clutch using a first actuator operation having a first closing ramp and a first opening ramp when the shift force having a first actuation duration; and
control the actuator to operate the clutch using a second actuator operation having a second closing ramp and a second opening ramp when the shift force has a second actuation duration different than the first actuation duration;
wherein at least one of the second closing ramp and the second opening ramp are shorter than the corresponding first closing ramp and the first opening ramp.

25. A motor vehicle comprising the control system according to claim 22 and a vehicle transmission having at least two gears, wherein the actuator and the clutch are operable to selectively engage and disengage the at least two gears in response to an from the manual gear shift.
